(19) United States
(12) Patent Application Publication
(10) Pub. No.: US 2006/0248712 A1
(43) Pub. Date: Nov. 9, 2006

(54) METHOD OF MANUFACTURING PRINTED CIRCUIT BOARD

(75) Inventors: Kyouyuu Jo, Ibaraki-shi, Osaka (JP); Yasufumi Miyake, Ibaraki-shi, Osaka (JP); Mitsuru Honjo, Ibaraki-shi Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Nitto Denko Corporation, Osaka (JP)

(21) Appl. No.: 11/382,067

(22) Filed: May 8, 2006

(30) Foreign Application Priority Data
May 9, 2005 (JP) 2005-136038

(51) Int. Cl. B32B 37/00

(52) U.S. Cl. 29/830; 29/846; 29/831; 156/247; 156/344

(57) ABSTRACT

A ground wiring layer and a signal wiring layer are formed on a base insulating layer. A cover insulating layer is formed on the base insulating layer with an adhesive layer therebetween to cover the ground wiring layer and the signal wiring layer except for a certain region on the ground wiring layer. An electromagnetic shield layer is formed on the certain region of the ground wiring layer and the cover insulating layer. A resin solution is applied on a release sheet and dried, so that a transfer sheet including the resin layer and the release sheet is formed. Then, the surface of the resin layer is placed on the top surface of the electromagnetic shield layer and these layers are heated and pressurized, so that the transfer sheet is laminated on the electromagnetic shield layer. Thereafter, the release sheet is removed.

### BACKGROUND OF THE INVENTION

1. Field of the Invention

The present invention relates to a method of manufacturing printed circuit board having an electromagnetic shield layer.

2. Description of the Background Art

With the advent of an increased variety of electronic equipment with high operating speed, noises such as electromagnetic waves generated from a printed circuit board in electronic equipment cause another electronic equipment to malfunction or electronic components to breakdown in some cases. Therefore, a technique of forming an electromagnetic shield layer that reduces electromagnetic waves radiated from the printed circuit board to the outside and high frequency noises coming into the printed circuit board from the outside has been proposed (see for example JP 7-302961 A).

In the conventional printed circuit board disclosed by JP 7-302961 A, a copper foil printed circuit covered with an undercoat layer of epoxy resin for example is formed on a heat-resisting plastic film. A conductive electromagnetic shield layer containing gold powder is formed on the undercoat layer. An overcoat layer (resin layer) for example of polyimide resin is formed on the electromagnetic shield layer to protect the electromagnetic shield layer against the external environment.

Note that the undercoat layer, the electromagnetic shield layer, and the overcoat layer are formed to expose the terminal of the copper foil printed circuit. The terminal is provided with electrolytic gold plating.

The overcoat layer for the conventional printed circuit board is formed by applying a resin solution on the electromagnetic shield layer by screen printing or the like, followed by drying.

When the overcoat layer is formed by applying the resin solution, however, pinholes can form on the overcoat layer in some cases. The pinholes form because the irregularities of the copper foil circuit formed on the printed circuit board cause bubbles to form when the resin solution is applied.

In this way, in the process of forming the electrolytic gold plating layer at the terminal of the printed circuit board, gold plating fills inside the pinholes, which ruins the appearance and gives rise to short-circuit. The gold plating filling the pinholes detaches to be like foreign matter and causes the electronic equipment to malfunction in some cases.

### SUMMARY OF THE INVENTION

It is an object of the invention to provide a method of manufacturing a printed circuit board, according to which pinholes are prevented from forming at a resin layer on an electromagnetic shield layer.

(1)

A method of manufacturing a printed circuit board according to one aspect of the invention includes the steps of preparing a shield circuit board having a wiring layer on an insulating layer and an electromagnetic shield layer that electromagnetically shields the wiring layer, preparing a transfer sheet having a layered structure including a resin layer and a release sheet, and transferring the resin layer of the transfer sheet onto the electromagnetic shield layer of the shield circuit board.

In the printed circuit board produced by the manufacturing method, the electromagnetic shield layer is provided to electromagnetically shield the wiring layer, so that electromagnetic waves generated from the wiring layer can be prevented from being externally radiated. Externally applied high frequency noises can be prevented from coming into the wiring layer. The resin layer is formed on the electromagnetic shield layer of the shield circuit board, and therefore the electromagnetic shield layer can be protected against the external environment.

According to the method of manufacturing a printed circuit board, the resin layer on the electromagnetic shield layer is formed by transferring the resin layer from the transfer sheet onto the electromagnetic shield layer rather than by directly applying a resin solution on the electromagnetic shield layer. In this way, pinholes can be prevented from forming at the resin layer on the electromagnetic shield layer.

(2)

The step of preparing the transfer sheet may include the step of forming the resin layer on one surface of the release sheet.

In this way, the release sheet has a flat surface without irregularities, and therefore bubbles can be prevented from forming in the resin layer when the resin layer is formed. Therefore, pinholes can be prevented from forming at the resin layer formed on the release sheet. Consequently, pinholes can be prevented from forming by transferring the resin layer onto the electromagnetic shield layer of the shield circuit board from the transfer sheet.

(3)

The step of transferring the resin layer of the transfer sheet may include the steps of joining the resin layer of the transfer sheet to the electromagnetic shield layer of the shield circuit board, and removing the release sheet from the resin layer of the transfer sheet.

In this way, the resin layer can readily be transferred to the electromagnetic shield layer by joining the resin layer of the transfer sheet to the electromagnetic shield layer of the shield circuit board, and removing the release sheet.

(4)

The step of joining the resin layer of the transfer sheet may further include the step of placing the resin layer of the transfer sheet on the electromagnetic shield layer of the shield circuit board, and heating and pressurizing these layers.

In this case, the transfer sheet is heated, so that the resin layer of the transfer sheet is dissolved or softened and deposited or adhered onto the electromagnetic shield layer of the shield circuit board. The transfer sheet and the shield circuit board are pressurized, so that bubbles in the dissolved or softened resin layer can be removed. In this way, the resin layer on the electromagnetic shield layer cures as it is removed of bubbles. Therefore, pinholes can be prevented from forming at the cured resin layer.

(5)

The step of preparing the shield circuit board may include the steps of forming the wiring layer having a prescribed pattern on the insulating layer, forming a cover insulating layer on the insulating layer to cover the wiring layer, and forming the electromagnetic shield layer on the cover insulating layer.

In this way, the wiring layer is formed on the insulating layer, and the cover insulating layer is formed on the insulating layer to cover the wiring layer. This allows the electromagnetic shield layer and the resin layer to be formed while the wiring layer is protected.

(6)

The resin layer may have a thickness from 5 μm to 50 μm. In this way, the electromagnetic shield layer can surely be protected against the external environment while the printed circuit board can still be reduced in thickness and its flexibility can be kept intact.

Other features, elements, characteristics, and advantages of the present invention will become more apparent from the following description of preferred embodiments of the present invention with reference to the attached drawings.

### BRIEF DESCRIPTION OF THE DRAWINGS

FIGS. 1 to 5 are sectional views for use in illustrating process steps in a method of manufacturing a printed circuit board according to one embodiment of the invention; and

FIG. 6 is a sectional view for use in illustrating process steps in another example of a method of manufacturing a transfer sheet.

### DESCRIPTION OF THE PREFERRED EMBODIMENTS

(1) Embodiment

Now, a method of manufacturing a printed circuit board according to one embodiment of the invention will be described with reference to the accompanying drawings.

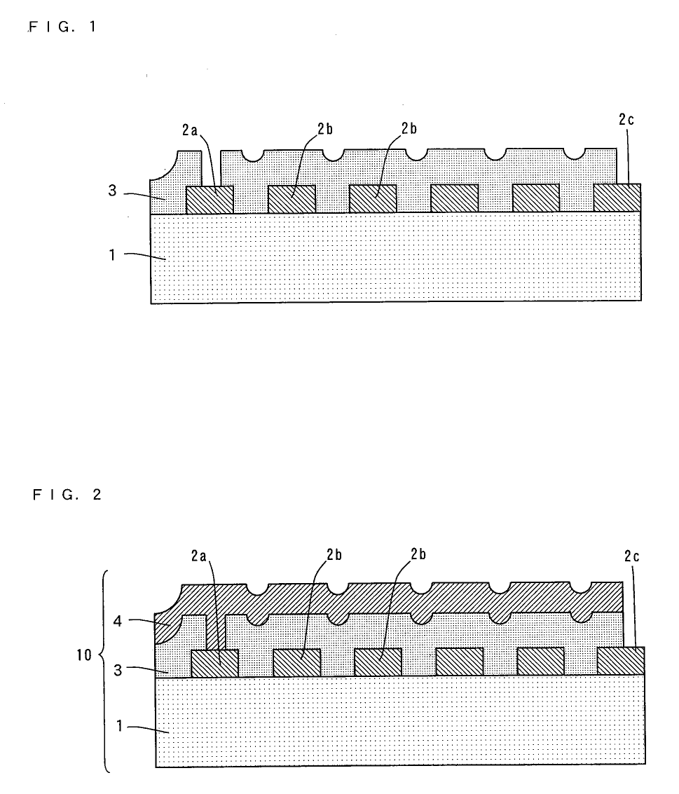

FIGS. 1 to 5 are sectional views for use in illustrating steps in the process of manufacturing a printed circuit board according to the embodiment of the invention.

As shown in FIG. 1, a ground wiring layer 2a and signal wiring layers 2b for example of copper are formed on a base insulating layer 1 for example of polyimide with an adhesive layer therebetween. Then, a cover insulating layer 3 for example of polyimide is formed on the base insulating layer 1 with an adhesive layer therebetween to cover the ground wiring layer 2a and the signal wiring layers 2b except for a certain region on the ground wiring layer 2a. At the time, a terminal 2c of the signal wiring layers 2b is exposed.

Then, as shown in FIG. 2, an electromagnetic shield layer 4 of a metal is formed on the certain region described above on the ground wiring layer 2a and the cover insulating layer 3. The electromagnetic shield layer 4 is formed by applying conductive paint such as silver paste. The electromagnetic shield layer 4 preferably has a thickness in the range from 5 μm to 35 μm. The ground wiring layer 2a and the electromagnetic shield layer 4 are electrically connected with each other.

In this way, a shield printed circuit board 10 including the base insulating layer 1, the ground wiring layer 2a, the signal wiring layers 2b, the terminal 2c of the signal wiring layers 2b, the cover insulating layer 3, and the electromagnetic shield layer 4 is formed.

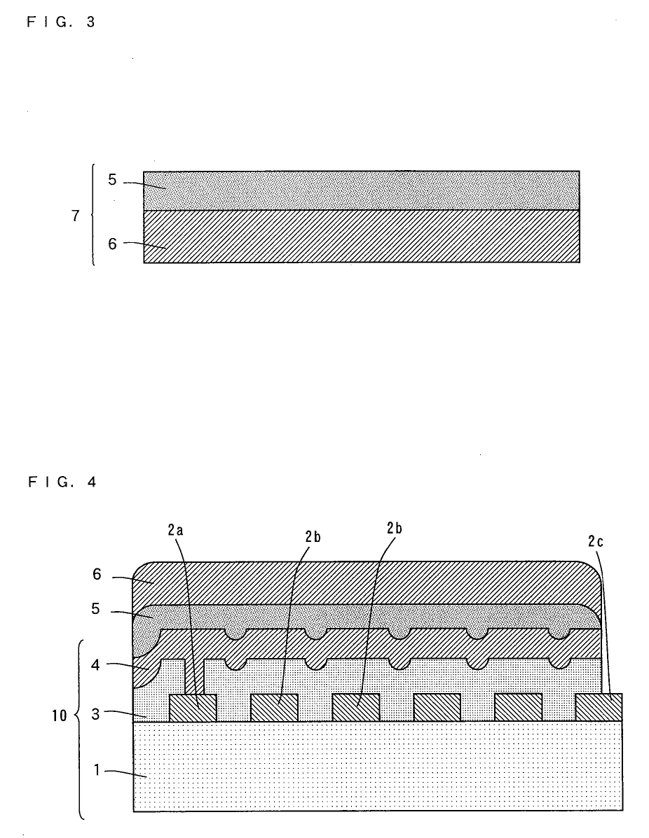

Meanwhile, as shown in FIG. 3, a resin solution is applied on a release sheet 6 for example of a polyethylene terephthalate film and dried, so that a transfer sheet 7 including a resin layer 5 and the release sheet 6 is formed. The release sheet 6 preferably has a thickness in the range from 25 μm to 50 μm. The resin layer 5 preferably has a thickness from 5 μm to 50 μm, more preferably from 5 μm to 35 μm.

The resin solution is produced for example by dissolving epoxy resin in a solvent such as methyl ethyl ketone. Acrylonitrile butadiene rubber or the like as a flexibilizer may be added to the resin solution. The concentration of the solid content in the resin solution is preferably from 20% by weight to 50% by weight. The surface of the release sheet 6 is treated with silicone or the like for release. In this way, the release sheet 6 can readily be removed from the resin layer 5.

Now, as shown in FIG. 4, the surface of the resin layer 5 is placed on the top surface of the electromagnetic shield layer 4, and then these layers are heated and pressurized, so that the transfer sheet 7 is laminated on the electromagnetic shield layer 4. At the time, the temperature is from 50° C. to 150° C., and the pressure is from 0.5 MPa to 5 MPa. Thereafter, the temperature is from 130° C. to 170° C., and thermal curing treatment is carried out for about three hours.

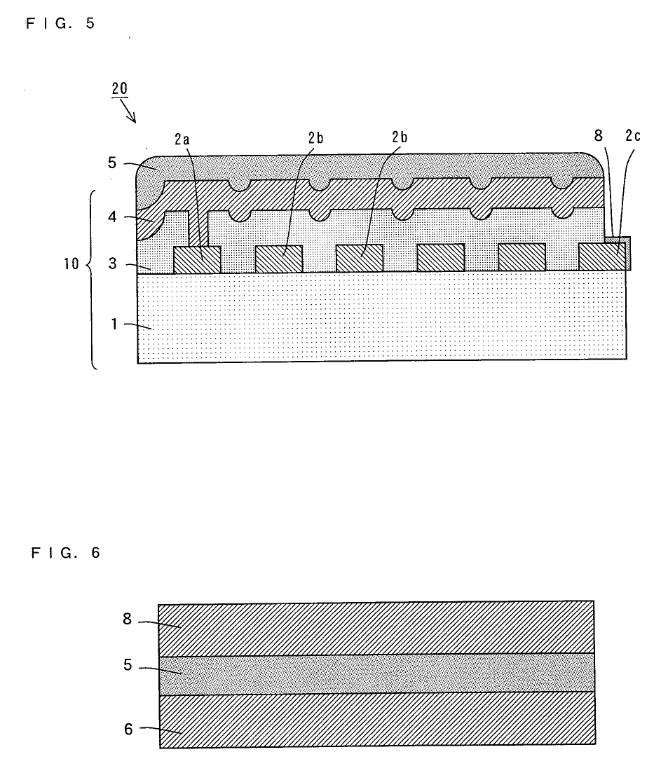

After the thermal curing treatment, the release sheet 6 is removed as shown in FIG. 5. Then, an electrolytic gold plating layer 8 is provided by electrolytic gold plating on the exposed terminal 2c.

In this way, a printed circuit board 20 including the shield circuit board 10, the resin layer 5 and the electrolytic gold plating layer 8 is formed.

By the method of manufacturing the printed circuit board 20 according to the embodiment, in the step of forming the resin layer 5 on the electromagnetic shield layer 4 of the printed circuit board 20, the transfer sheet 7 including the resin layer 5 and the release sheet 6 is heated and pressurized, so that the transfer sheet 7 is laminated on the electromagnetic shield layer 4.

In this way, bubbles can be prevented from forming in the resin layer 5. Therefore, pinholes can be prevented from forming on the resin layer 5. Consequently, in the step of forming the electrolytic gold plating layer 8 on the terminal 2c of the signal wiring layers 2b, gold plating can be prevented from filling the pinholes.

As described above, in the step of producing the transfer sheet 7, the resin solution is applied on the release sheet 6 and dried to form the resin layer 5. In this way, the release sheet 6 has a flat surface without irregularities, and therefore bubbles can be prevented from forming in the resin layer 5. If bubbles form in the resin layer 5 and pinholes are formed accordingly, the transfer sheet 7 is heated and pressurized in the following step in FIG. 4, so that the resin layer 5 dissolves and the pinholes are eliminated.

(2) Other Embodiments

As the material for the base insulating layer 1 and the cover insulating layer 3, which is not limited to polyimide, any other insulating material such as a polyethylene terephthalate film, a polyethernitrile film, or a polyethersulfone film may be used.

As the material for the ground wiring layer 2a and the signal wiring layers 2b, which is not limited to copper, any other metal materials such as a copper alloy, gold, or aluminum may be used.

As the material for the adhesive layer, an epoxy-based adhesive or a polyimide-based adhesive may be used. According to the embodiment described above, the ground wiring layer 2a and the signal wiring layers 2b are formed on the base insulating layer 1 with the adhesive layer therebetween, but the adhesive layer may not be used if the adhesion between the base insulating layer 1 and the ground wiring layer 2a, and between the base insulating layer 1 and the signal wiring layers 2b is sufficiently provided. Similarly, the cover insulating layer 3 is provided on the base insulating layer 1 with the adhesive layer therebetween to cover the ground wiring layer 2a and the signal wiring layers 2b, but the adhesive layer may not be used if the adhesion between the base insulating layer 1 and the cover insulating layer 3 is sufficiently provided.

As the material for the electromagnetic shield layer 4, which is not limited to silver paste, any other conductive paint such as copper paste, paste containing nickel powder, or paste containing stainless steel powder may be used. According to the embodiment, the electromagnetic shield layer 4 is formed by applying the conductive paint, while the electromagnetic shield layer 4 may be formed by a different method such as sputtering and plating.

As the material for the resin layer 5, which is not limited to the epoxy resin, a resin material such as polyimide resin, polyester resin, polyethylene naphthalate resin, or acrylic resin may be used. Either thermosetting resin or thermoplastic resin may be used.

As the solvent for the resin solution, which is not limited to methyl ethyl ketone, a solvent such as toluene, ethylene glycol, monomethyl ether, ethylene glycol monoethyl ether, dioxane, or methyl cellosolve acetate may be used.

As the material for the release sheet 6, which is not limited to polyethylene terephthalate, a material such as paper may be used.

Note that if the produced transfer sheet 7 is stored without being immediately used for lamination on the electromagnetic shield layer 4, another release sheet 8 may be formed on the resin layer 5 as shown in FIG. 6. In this case, before the transfer sheet 7 is laminated on the electromagnetic shield layer 4, the release sheet 8 is removed.

Although epoxy resin that is thermosetting resin is used as the material for the resin layer 5 in the embodiment, the thermal curing treatment after the lamination may not be performed when thermoplastic resin such as polyimide resin is used.

### INVENTIVE EXAMPLE

A printed circuit board according to an inventive example was produced by the steps in FIGS. 1 to 4.

The electromagnetic shield layer 4 was made of silver paste and as thick as 15 μm. The resin solution for forming the resin layer 5 had a composition given in Table 1.

TABLE 1

| | material | mass[g] |
|---|---|---|
| composition | epoxy resin: | 100 |
| | brominated bisphenol A epoxy resin | |
| | (epoxy equivalent of 625, 50 wt % | |
| | bromine content) | |
| | curing agent: | 4 |
| | phenol novolac resin (hydroxyl | |
| | equivalent of 106) | |
| | accelerator: | 2 |
| | 2-undecyl imidazole | |
| | flexibilizer: | 33 |
| | carboxyl containing acrylonitrile | |
| | butadiene rubber | |
| | solvent: | 105 |
| | toluene | |
| | solvent: | 105 |
| | ethylene glycol monomethyl ether | |

In the step shown in FIG. 3, a resin layer 5 of the resin solution in Table 1 was formed on a release sheet 6 of a polyethylene terephthalate film, and a transfer sheet 7 including the release sheet 6 and the resin layer 5 was formed.

In this example, the release sheet 6 was coated with the resin solution using a reverse coater, followed by drying for three minutes at 100° C. In this way, the resin layer 5 was formed. The resin layer 5 had a thickness of 10 μm.

In the step shown in FIG. 4, the transfer sheet 7 was laminated on the electromagnetic shield layer 4 using a hot press. In this example, the temperature was 110° C. and the pressure was 3 MPa. The thermal curing treatment was carried out for three hours at a temperature of 150° C.

### EVALUATION

In the printed circuit board according to the inventive example, no pinhole was observed on the resin layer 5. It was therefore found that when the resin layer 5 is formed by laminating the transfer sheet 7 on the electromagnetic shield layer 4, no pinhole is formed at the resin layer 5.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A method of manufacturing a printed circuit board, comprising the steps of:
preparing a shield circuit board having a wiring layer on an insulating layer and an electromagnetic shield layer that electromagnetically shields said wiring layer;
preparing a transfer sheet having a layered structure including a resin layer and a release sheet; and
transferring said resin layer of said transfer sheet onto said electromagnetic shield layer of said shield circuit board.

2. The method of manufacturing a printed circuit board according to claim 1, wherein said step of preparing the transfer sheet comprises the step of forming said resin layer on one surface of said release sheet.

3. The method of manufacturing a printed circuit board according to claim 1, wherein said step of transferring said resin layer of said transfer sheet comprises the steps of:
joining said resin layer of said transfer sheet to said electromagnetic shield layer of said shield circuit board; and
removing said release sheet from said resin layer of said transfer sheet.

4. The method of manufacturing a printed circuit board according to claim 3, wherein said step of joining said resin layer of said transfer sheet further comprises the step of placing said resin layer of said transfer sheet on said electromagnetic shield layer of said shield circuit board, and heating and pressurizing these layers.

5. The method of manufacturing a printed circuit board according to claim 1, wherein said step of preparing the shield circuit board comprises the steps of:
forming said wiring layer having a prescribed pattern on said insulating layer;
forming a cover insulating layer on said insulating layer to cover said wiring layer; and
forming said electromagnetic shield layer on said cover insulating layer.

6. The method of manufacturing a printed circuit board according to claim 1, wherein said resin layer has a thickness from 5 μm to 50 μm.
